(19) United States
(12) Patent Application Publication
(10) Pub. No.: US 2025/0384404 A1
(43) Pub. Date: Dec. 18, 2025

(54) System to create and process criterion for qualifying if an appointment is completed successfully per criterion, and facilitate payment actions of holds, payout, and/or remittance of payment, when criterion are met or not met therein.

(71) Applicant: DAVID ISAAC GOODLEY, LAS VEGAS, NV (US)

(72) Inventor: DAVID ISAAC GOODLEY, LAS VEGAS, NV (US)

(21) Appl. No.: 19/237,892

(22) Filed: Jun. 13, 2025

(51) Int. Cl. G06Q 10/109; G06Q 10/0631; G06Q 20/28

(52) U.S. Cl. CPC G06Q 10/109; G06Q 10/06315; G06Q 20/28

(57) ABSTRACT

A System to create and process appointments, both business and personal, with various criterion being set and subsequently confirmed or not confirmed within System to constitute a completion, or non-completion of said appointment, with non-completion of appointment criterion such as date, time, and documentation resulting in payment being released to a specific party of the appointment. “Appointment” being the sum of all criterion specified by System users. System may be deployed on mobile computing devices to include “smart phones” as an application, along with local, or web-based computer software.

### CROSS-REFERENCE TO RELATED APPLICATIONS

### U.S. PATENT DOCUMENTS

US 20090006416 A1

US 20220253320 A1

US 2008/0140458 A1

US 2018/0204188 A1

### BACKGROUND OF THE INVENTION

With any appointment between two parties, there is a risk involved in parties cancelling, “no-showing”, or causing wasted time. This often causes direct or indirect financial losses. This system and service ensures that all parties to any appointment may be held financially accountable, are pre-qualified as having the funds to cover non-completion of an appointment, have met selectable criterion, as well as entering into a contractual agreement for completing a variety other criterium pertaining to the appointment(s). These features are included in a single digital application, which can be web or digital device based.

### SUMMARY OF THE INVENTION

Definitions: “Appointment” may be used interchangeably with any of the following terms: “Reservation,” “Booking,” “Viewing,” “Meeting,” “Session,” “Commitment.”

Digital system, service and architecture to create, hold, and release or remit payments by automation, based on a variety of criterion being met or not met, with the purpose of ensuring appointments, both personal and business, are held or financial compensation is made for failure to keep any of the appointment criterion. Said system is encompassed within a single system architecture. Conditional criteria to set an appointment and successfully complete the appointment include, but are not limited to: payment price for failure to keep/meet appointment criterion; documentation requirements (ID, financial verification, etc.); time requirements; date requirements; location requirements, etc. Users may define their own criterion.

### BRIEF DESCRIPTION OF DRAWINGS

FIG. 1. Shown is the operational architecture of System application. This includes integrations and ancillary processes incorporated to create whole System.

FIG. 2. Shown is a flowchart which demonstrates the System's core process functionality in setting criterion and the consequent Boolean calculations.

FIG. 3. Shown is a flowchart demonstrating the System's workflow to confirm and complete an appointment, including Boolean qualifiers if criterion are met or not, resulting in payment remittance or release.

FIG. 4. Shown is a flowchart which outlines the process in which System interacts with data from other systems to verify if conditions/criterion are met or not met.

FIG. 5. Shown is a flowchart example of System functionality, referencing use in a real-estate application. This example is further outlined in the detailed description.

FIG. 6. Shown is a flowchart example of System functionality, referencing use in a business meeting application. This example is further outlined in the detailed description.

### DETAILED DESCRIPTION OF THE INVENTION

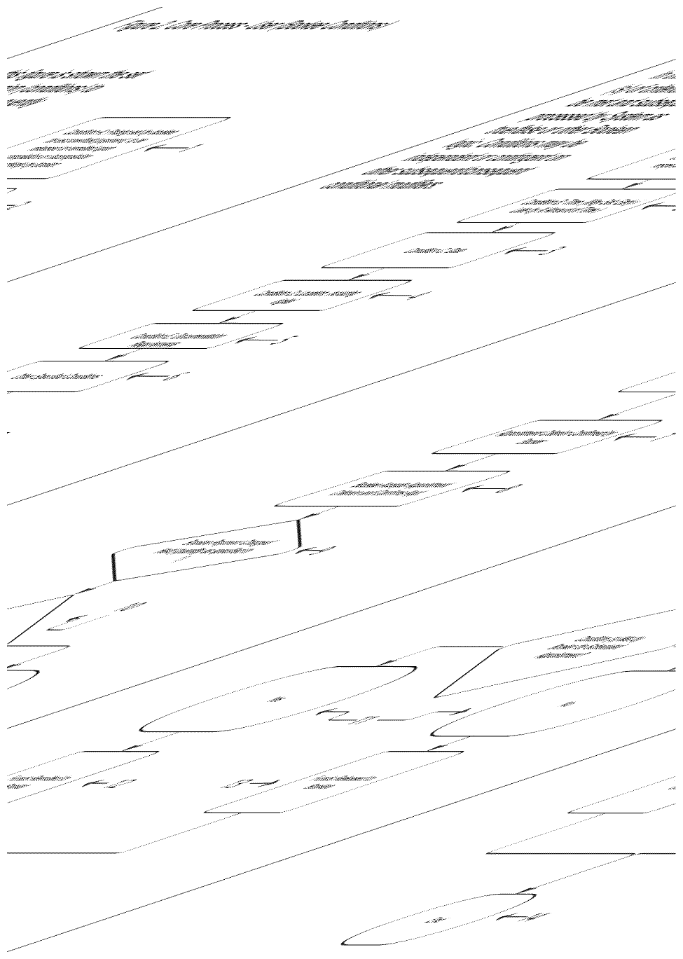

System functions as a service for qualifying if appointments have been met based on processing and interpreting any variety of applicable digital data, along with holding monetary funds until criterion and their related data pertaining to an appointment have been processed and qualified as met or not met by System. These criterion are shown in FIG. 2. They may include any combination of criteria such as Time (2), Date (3) Location (4), Documentation requirements (5), and Other Specified Conditions (6) along with setting a specific monetary amount for non-completion of any combination of criteria (1).

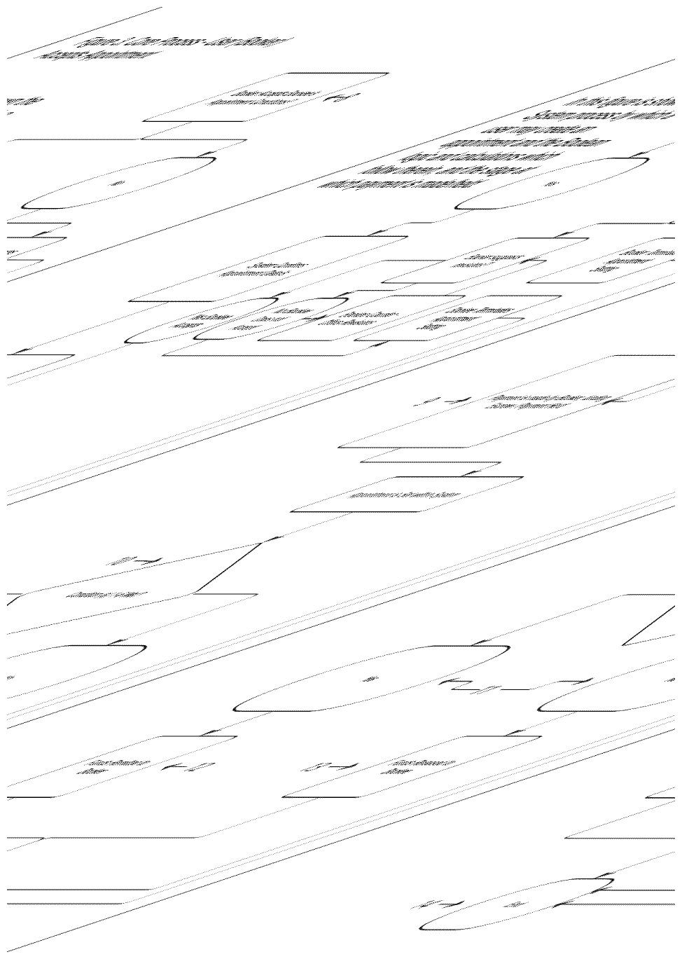

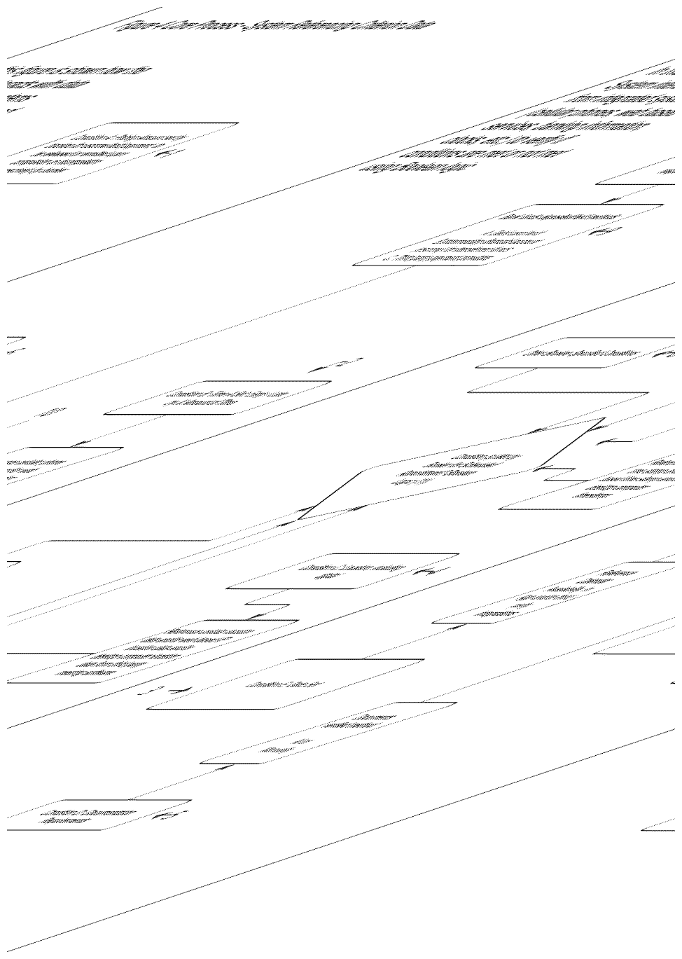

System captures and processes data, then computes using Boolean logic (10) FIG. 2-6, to qualify if criterion as set by user(s) have been met (11). Based on that logic and conclusions if an appointment has been met, or not met, the System will disburse (13) or remit (12) held payment to the applicable parties. After payment, the System process for that specific appointment is terminated (14).

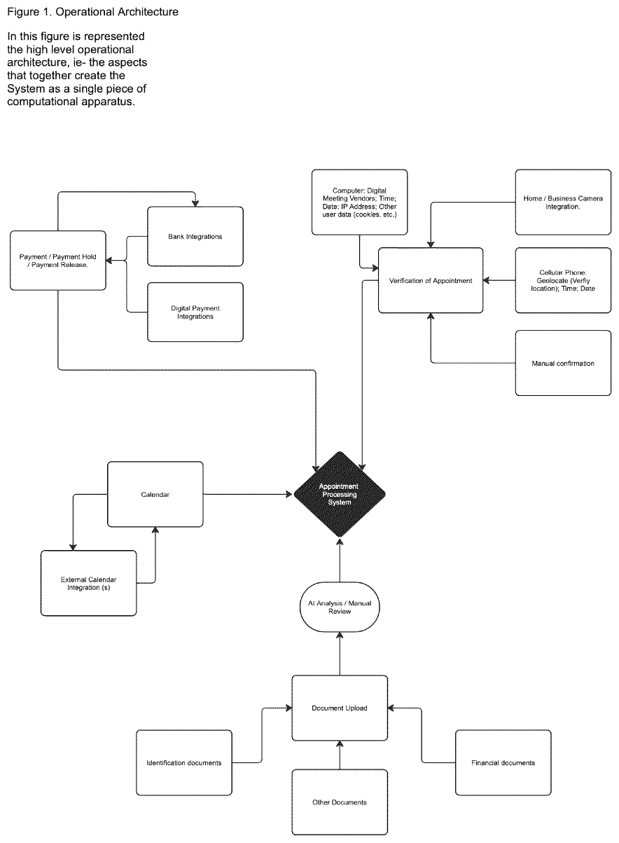

System captures data from a variety of integrated electronic and digital devices such as: cellular phones, computers, optical equipment, audio recording devices, in a variety of forms such as digital images, digital audio recordings, optical data, geographical data, time stamps, documents, calendars, email, external vendor information (such as in digital meeting participation), then processes the data and cross-references it with user-specified criterion (FIG. 1) using Boolean logic. Banking and payment services are integrated into System to complete any payouts that may be applicable based on criterion being met or not met. This high level system architecture is shown in FIG. 1.

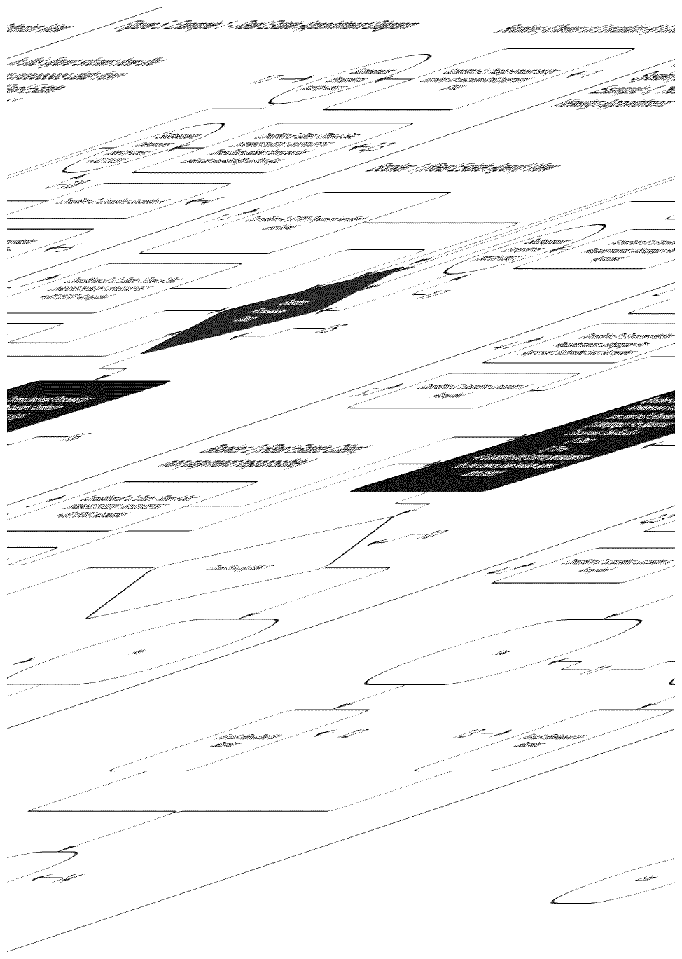

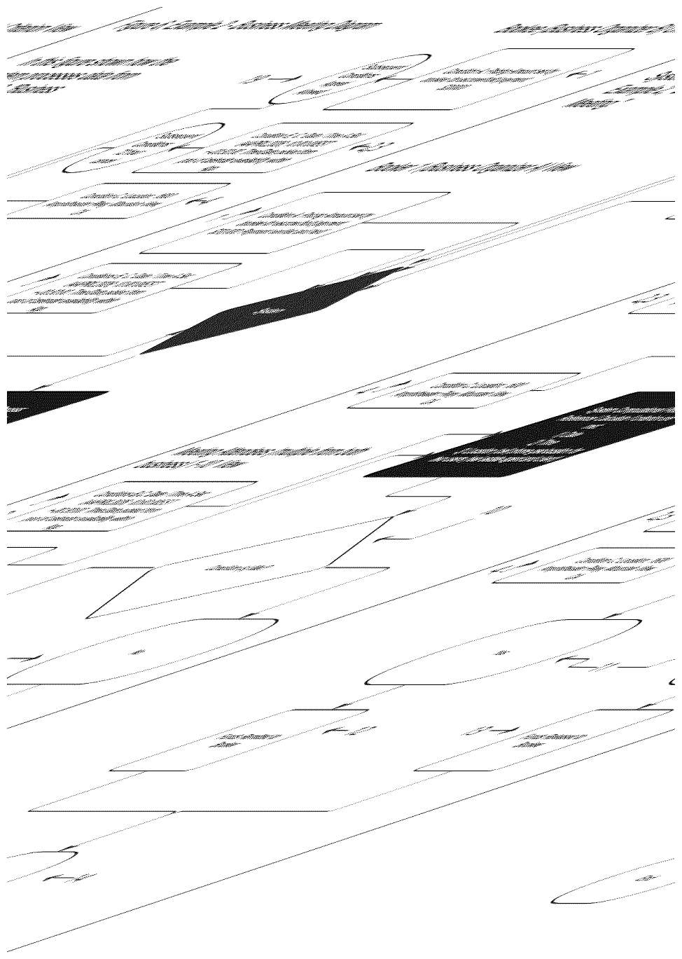

Because in any given appointment context there are innumerable possibilities for criterion, the scope is virtually unlimited to define, outside of defining the structure itself. These possibilities are shown as “Subsequent Exceptions,” (17) “Subsequent Tolerances,” specifically in reference to time as a plus or minus figure in minutes and hours, (18) and “Subsequent Conditions,” (19) in FIGS. 5-6. Examples of use cases include:

### Example 1: Real Estate Viewing Appointment (FIG. 5)

### Brief

Real estate viewings of all prices, both commercial and private entail a sizable amount of preparation requiring both time and money. This can include cleaning services, coordinating family members and employees to be off the premises, salaries, etc. Currently there are only “good faith” means of keeping appointments of these types. This puts the financial and temporal onus completely on the seller. Frequently appointments are cancelled without a previously agreed upon notice period and/or missed without any notice at all (a “no show.”) System creates a framework and automated system to reduce risk for both parties.

### Example

Client A has listed their home online on the Multiple Listing Service (MLS). Realtor 1 has two clients (Client 1, Client 2) who wish to view the home (Location A) on March 26th at 6:00 PM (Date and Time). As a user of System, Owner of Location A (Bookee) has specified that viewing appointments require the following:

### Criterion

Date: Mar. 26, 2026 (5)
Time: 18:00:00 PT+−00:15:00 (2)
Meeting Place: Location A (3)
Change Notification Requirement? Yes, 72 hours. (18)
Non-Completion Fee: $100 (1)
Applicable to all parties? No, Applicable to Realtor 1, Client 1 (17)
Permit Contestation of Fee Payout? No (19)
Permit Modification of Fee Payout after non-compliance? No (19)

With these criterion (1-6) set by Bookee (Client A), Realtor A proceeds to make a booking using System one week in advance. At this point a hold is placed on his desired payment method within his System account. Realtor A must appear at home address on March 26th at 6:00 PM (+−15 minutes) or forfeit payment of $100 to Bookee (Client A).

System begins by processing analyzation of the documentation uploaded by Booker, as specified by Bookee, and provides either an artificial intelligence (Al) analysis, or by presenting the document to Client A for manual review and approval. Client A reviews the document and confirms approval for the appointment. Document submission may be either necessary or unnecessary to create initial booking, dependent on user settings. Any set of criteria may be set as necessary or unnecessary, along with time for completion triggering a payment or remittance of payment.

Next, on March 26th at time specified within System, in this case Time of Appointment—Mar. 26, 2026 18:00:00 PT, System begins capturing cellular telephone data in the form of geographic location, time and date. It then processes this data to confirm yes/no-is Realtor A at Location A (15)?

If Yes, Payment hold is withdrawn and funds are returned to Realtor A. (10)

If No—Payment of $100 is then processed and placed into Client A's User Account. (10) In this example both Realtor and Client (Bookers) are “no-shows.” After the specified grace period of 20 minutes, as defined within System, payment of $100 is released to Bookee (Client A).

### Example 2: Business Meeting. (FIG. 6)

### Brief

Meetings are a common and necessary part of any business, either for profit or not, public or private. These meetings can be large and of great importance, in the event of a company acquisition, costing many thousands of dollars in payroll time (the temporal equivalent of the pay wasted through wasted time of parties involved), or these could be as simple as a job interview with just two people and perhaps only $20 worth of lost time. In any case, the business loses money through loss of efficiency and ability to recuperate said monetary value. There is currently no way for businesses to ensure their time is kept useful and efficient should a person or party cancel without a previously agreed upon notice period. System provides a solution in keeping all parties accountable for fulfilling the criterion as set within System.

### Example

Business A (BA), publicly held, has approached Business B (BB), privately held, about the possibility of acquiring them. Initial talks and information have gone well, and now a formal meeting (Meeting) involving a number of high-level executives from both parties has been informally agreed upon. The meeting will be 2 hours (2) and involve 10 people from BA and BB respectively located at address 1600 Amphitheatre Parkway in Mountain View, California (4). BA and BB agree to use System to coordinate, set criterion, and book Meeting. System allows both parties to set an agreed-on payment hold in the event that criterion are not met by either party, in this case $20,000 (1).

Both parties agree that the meeting will take place on Apr. 2, 2026 at 10:00:00 Eastern Time and must involve the required people (10 from each business) or incur the payment transference from non-compliant party to compliant party. Options within System are available to cover any variety of circumstances, including if both parties are non-compliant in meeting criterion.

### Criterion

Date: Apr. 2, 2026 (FIG. 2., 3)
Time: 10:00:00 ET+−00:30:00 (FIG. 2, 2)
Meeting Place: 1600 Amphitheatre Parkway in Mountain View, California (FIG. 2, 4)
Change Notification Requirement? Yes, 72 hours. (FIG. 5, 17)
Non-Completion Fee: $20,000 (FIG. 2, 1)
Applicable to all parties? Yes (FIG. 5, 17)
Permit Contestation of Fee Payout? Yes (FIG. 6, 17)
Permit Modification of Fee Payout after non-compliance? Yes (FIG. 6, 17)
Arbitration maximum time (time allowed to re-negotiate terms before payout is automatically sent). 48 hours. (FIG. 6, 17)

System will allow notes and edits to criterion, to be mutually approved before payment hold may be made by either party. There is no limit to how many parties may be added to System, however in this example there are two.

BA and BB add System to all involved parties cellular phones for verification. User levels and permissions may be set by System admins, in this example an executive admin from each team was responsible for coordinating the meeting, and have set the other people involved in the meeting to mandatory, as such that user's mobile device data in the form of location, time and date, will be verified by System (10) as part of the meeting criterion (1-6).

The meeting is set within System and both parties have a $20,000 hold placed on their respective payment methods (1). BA and BB have agreed that no cancellations are permitted without criterion non-compliance within 72 hours of Meeting (2,3, 17).

On Apr. 1, 2026, BA informs BB that their CEO, a required participant and the CFO, also a required participant are unable to make Meeting. System user BB may initiate a non-compliance claim, which will require confirmation from BA, or they may wait until

Meeting date/time/location to pass, in which case System will automatically release the $20,000 payment based on non-completion of criterion. In this example BB will initiate a non-compliance claim, and BA will approve that to save on unused travel for example. BB may, at their will, take full payment, or take a reduced payment, or cancel payment based on their desire, based on the Other Specified Conditions that were created and set in System (6).

In this case BB requires proof of an “Act of God” to be submitted into System through the document upload, otherwise they will take full payment. Using System they set the criterion as at least two official documents per Meeting participant (four total documents), as well as setting the submission requirement to with 24 hours, also falling within the 48 hour maximum for Arbitration.

BA provides a hospital and police report for both their CEO and CFO (they were involved in a car accident in this case). BB confirms and accepts the documentation, and payment is either remitted to both BA and BB, or kept within System in the event of a rescheduling of Meeting.

### Example 3: Business Interview

### Brief

In a less complex use-case than example 2, this example is of a simple two person job interview.

Because of the nature of job interviews, no-shows at all echelons of business are common. This involves wasted time and consequently wasted money. System creates interface which results in payment to either party if agreed upon criterion, such as time and date, are not met.

### Example

Person A has an online job interview with Recruiter B. They agree by email to meet via a third party online audio-video platform, which we will call “Platform Z.” The agreed upon details are:

### Criterion

Time: 09:00:00+−00:10:00 (2)
Date: Apr. 4, 2026 (3)
Change Notification Requirement? Yes, 24 hours.
Meeting Place: Platform Z via PC (4)
Non-Completion Fee: $50 (1)
Applicable to all parties: Yes (6)
Permit Contestation of Fee Payout? No (17)
Permit Modification of Fee Payout after non-compliance? No (17)

System will then analyze various data from both party's computers, including but not limited to data from APIs, screen recording, audio recording, IP addresses, etc. to determine compliance.

In this example, both parties attend the meeting via Platform Z, on time and conclude in compliance. System automatically remits the payment fee of $50 to each user.

### Example 4: Online Date

### Brief

Online dating presents the opportunity for two strangers to meet. Frequently, however, this results in one party not attending the meeting without notice (“ghosting”), often at significant cost and time to the other party. System provides a framework to ensure compensation if either party is non-compliant to the pre-agreed upon criterion.

### Example

Person A finds Person B through an Online Dating Platform (ODP). System may be used as a stand-alone App, or through integrations via API or other third party integration. In this example Person A and Person B will use it as a stand-alone.

Person A suggests to Person B that they meet at John's Pizza Shop, on Apr. 5, 2026 at 21:00:00 Pacific Time. Person B Agrees and stipulates that they use System to ensure the date is kept. Person A agrees to the criterion Person B has set:
Time: 21:00:00 PT+−00:20:00 (2)
Date: Apr. 5, 2026 (3)
Meeting Place: John's Pizza Shop (4)
Change Notification Requirement: 48 hours (17)
Non-Completion Fee: $20 (1)
Identity documentation verification required? Yes (6)
Applicable to all parties? No, only (6)
Permit Contestation of Free Payout? No (17)
Permit Modification of Free Payout after non-compliance? Yes (17)

Person A uses System installed on their mobile phone to agree to criterion. A payment hold is then made to his account for the agreed on amount of $20. Person B receives a notice through System that the date has been set.

On Apr. 5, 2026, Person A drives to John's Pizza Shop and is there at 21:00:00. This is verified by System through use of geolocation via their mobile telephone. Person B is running late and messages A that they will arrive at 21:30:00, outside of the +−20 minute time window. However, since this non-compliance agreement was only applicable to Person A as the initiator, after the time of day passes 21:20:00 without System verifying Person B's attendance, the only action to occur within System is the remittance of their $20 payment hold, and the closing of the appointment.

1. A system and system architecture comprising:
A web-based application comprising one or more software platforms for executing cloud and local software; and application software encoded in the application system for execution by one or more cloud or local based processors, the application software implementing a plurality of service operations, the service operations comprising of the following aspects acting as a whole system:
A. An appointment booking operation operable by multiple parties, in conjunction with;
B. A series of criteria, correlating to digital data to include any combination of the following data to process and verify criteria as met/not met:
i. Location information based on any of the following:
a. IP Address Geolocation
b. GPS Data
C. Wi-Fi Positioning System (WPS)
d. Cell Tower Triangulation
e. Browser Geolocation API
f. Mobile Network Location (Carrier Data)
g. Bluetooth Beacons
h. Check-ins or Self-reported Data
i. Device Fingerprinting with Location Hints
j. Photo Metadata (EXIF)
k. Audio data
I. Optical/Visual data
ii. Date information
iii. Time information
iv. Documentation
a. Identification
b. Financial (mortgage approvals, bank statements, credit statements, etc.)
c. User defined
v. User defined criteria
C. A system that includes placing a hold on a payment, then remits payment, or releases it to defined parties based on automated verification of criterion specified (as listed above, B, i-v.)
D. A system that includes any combination of automated digital Boolean calculation functions regarding claim 1.B.i-v., to determine “Yes/No”, “True/False”, “If/Then”, and “And/Or/Not” to determine if appointment has been successfully completed.
E. A system that allows two or more users access to edit and approve the criterion to be specified by users.
F. A system which allows manual adjustment and approval or disapproval of automated verifications of criterion as set by user(s).
